(19) United States
(12) Patent Application Publication
(10) Pub. No.: US 2026/0024451 A1
(43) Pub. Date: Jan. 22, 2026

(54) PRONUNCIATION CORRECTION SYSTEM FOR HEARING-IMPAIRED INDIVIDUALS

(71) Applicant: NATIONAL YUNLIN UNIVERSITY OF SCIENCE AND TECHNOLOGY, Douliu City (TW)

(72) Inventors: Jeng-Shin SHEU, Douliu City (TW); Cheng-Huan LI, Douliu City (TW); Yen-Da FENG, Douliu City (TW)

(21) Appl. No.: 19/018,003

(22) Filed: Jan. 13, 2025

(30) Foreign Application Priority Data
Jul. 18, 2024 (TW) 113126935

(51) Int. Cl. G09B 5/06; G10L 15/187; G10L 21/034; G10L 21/0364; G10L 25/18

(52) U.S. Cl. CPC G09B 5/06; G10L 15/187; G10L 21/034; G10L 21/0364; G10L 25/18

(57) ABSTRACT

The present invention is a pronunciation correction system for hearing-impaired individuals. It employs an audiometry module to generate hearing impairment data for the hearing-impaired individual. A frequency enhancement module then uses this data to establish a gain model, which is applied to adjust multiple word audios, enabling the hearing-impaired individual to clearly hear the adjusted audios. An assistive learning module plays the adjusted word audios and captures the utterances repeated by the hearing-impaired individual. A speech recognition module performs speech recognition on these utterances, comparing the recognition result with the text labels corresponding to the word audios. The comparison results are sent back to the assistive learning module, which displays visual feedback to display the results. This process assists the hearing-impaired individual in correcting the pronunciation effectively.

### CROSS-REFERENCE TO RELATED APPLICATION

The present application claims priority to Taiwan Patent App. No. 113126935, filed Jul. 18, 2024, the entirety of which are incorporated by reference herein.

### FIELD OF THE INVENTION

The present invention relates to a pronunciation correction system, and more particularly to a pronunciation correction system for hearing-impaired individuals.

### BACKGROUND OF THE INVENTION

Children's language development starts with developing auditory abilities, followed by learning to repeat utterances. In cases of hearing impairment, this learning process can be disrupted, resulting in difficulties in accurate pronunciation. Pure tone audiometry (PTA) is used to assess hearing. This method measures hearing by playing pure tones at various frequencies and amplitudes, recording the softest sound the user can hear at each frequency, and thus determining the level of hearing impairment.

Once hearing impairment is identified, hearing aids or cochlear implants can help restore hearing to functional levels for daily life. However, correcting pronunciation errors requires long-term training to achieve gradual improvement. This process typically involves guidance from speech-language therapist, who assists individuals in producing accurate sounds, using vocal cords correctly, and establishing a connection between hearing and pronunciation to enhance overall speech clarity.

The cost of speech therapy, however, is often quite high, and noticeable improvements take time, making it difficult for children with hearing impairments to access consistent, long-term therapy. To address this issue, Taiwan Patent TWI578287B introduces a voice evaluation device and a continuous speech visualization method for pronunciation learning systems. This device functions as a pronunciation correction system by comparing a continuous word learner curve, formed when a user reads a series of words, with a reference curve pre-established in the system. Through this comparison, users can receive feedback on their pronunciation and practice continuously, using visual aids to support oral learning and rehabilitation for hearing-impaired patients.

Despite these advancements, hearing aids and cochlear implants cannot fully restore auditory perception for hearing impaired users. As a result, when using the aforementioned pronunciation correction system, the individuals are unable to “hear correct sounds and mimic them effectively.” This limitation significantly reduces the system's effectiveness, often requiring excessive effort for minimal improvement.

### SUMMARY OF THE INVENTION

The primary objective of the present invention is to provide a pronunciation correction system for hearing-impaired individuals, enabling them to hear correct sounds and learn to replicate them effectively.

To achieve this, the invention comprises an audiometry module, a frequency enhancement module, an assistive learning module, and a speech recognition module:
1. Audiometry Module: Generates hearing impairment data specific to the user.
2. Frequency Enhancement Module: Establishes a gain model based on the hearing impairment data and the auditory profile of a normal individual. It adjusts word audios to align with the auditory perception of a normal listener, allowing the hearing-impaired user to experience equivalent sound quality.
3. Assistive Learning Module: Plays the adjusted word audios for the user to listen and captures the user's repeated utterances in response to hearing them.
4. Speech Recognition Module: Analyzes the user's repeated utterances, compares them with the corresponding text labels of the original word audios, and generates a comparison result. This result is fed back to the assistive learning module for display as visual feedback.

By first generating hearing impairment data to establish a personalized gain model, the system adjusts word audios to provide the user with a normal auditory experience. This enables hearing-impaired individuals to hear correct sounds and improve their pronunciation through guided repetition learning. This integrated use of assistive learning and speech recognition modules enhances efficiency, achieving greater results with less effort.

### BRIEF DESCRIPTION OF THE DRAWINGS

FIG. 1 illustrates a block diagram illustrating the components of the system in the present invention.

FIG. 2 illustrates a test interface used for a pure tone audiometry method in the present invention.

FIG. 3 illustrates a learning interface designed for assistive learning in the present invention.

FIG. 4 illustrates a screen displaying a comparison result indicating a correct pronunciation in the present invention.

FIG. 5 illustrates a screen displaying a comparison result indicating an incorrect pronunciation in the present invention.

### DETAILED DESCRIPTION OF THE PREFERRED EMBODIMENT

The detailed description and technical content of the present invention are provided below in conjunction with the accompanying drawings.

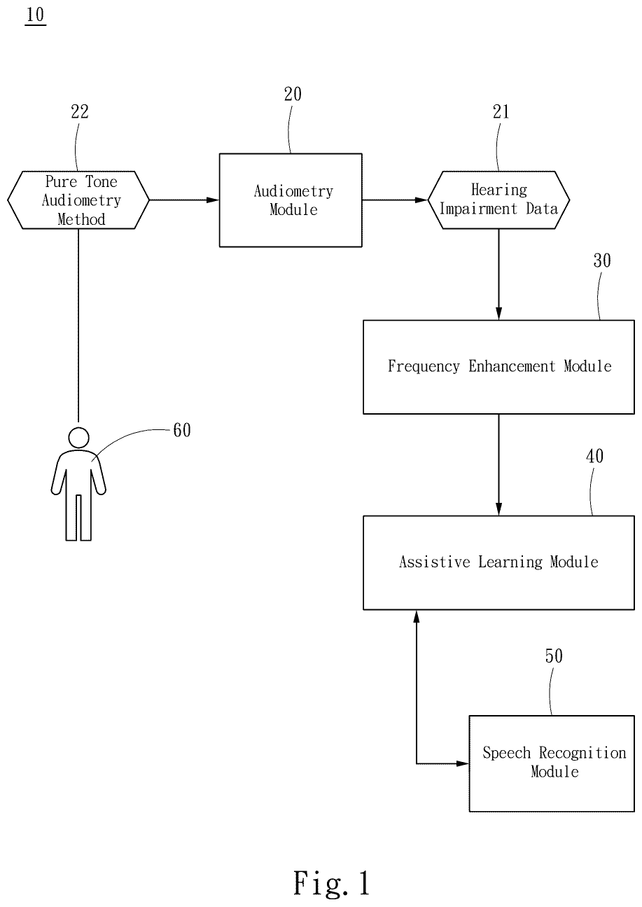

Referring to FIG. 1, the present invention provides a pronunciation correction system 10 designed for hearing-impaired individuals. The system includes an audiometry module 20, a frequency enhancement module 30, an assistive learning module 40 and a speech recognition module 50.

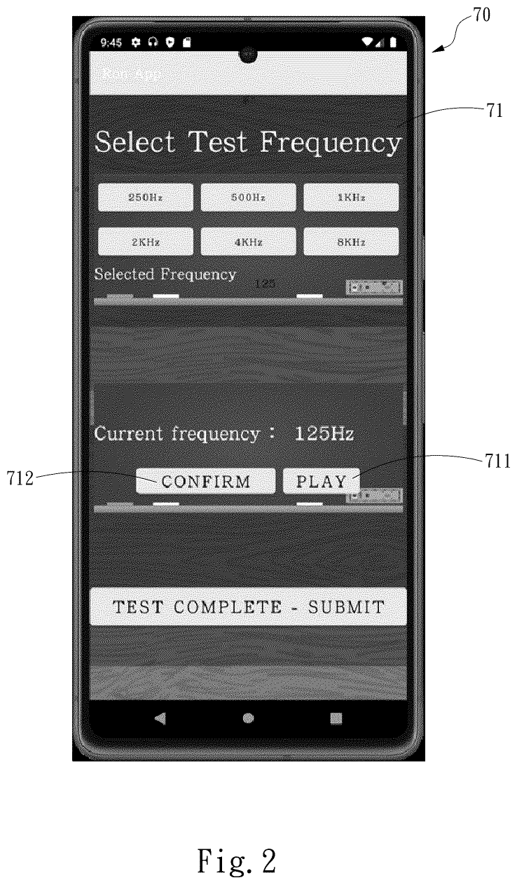

Referring to FIG. 2, the audiometry module 20 is responsible for generating a hearing impairment data 21 for a hearing-impaired individual 60. In one embodiment, the audiometry module 20 executes a pure tone audiometry method 22 via an APP on a mobile phone 70. FIG. 2 illustrates a test interface 71 of the pure tone audiometry method 22. This APP sequentially plays a plurality of pure tones with different frequencies and volumes through the mobile phone 70. In one example, the plurality of pure tones is a series of pure tones. The audiometry module 20 determines whether the hearing-impaired individual 60 perceives these pure tones based on their responses. For each of these pure tones, a hearing threshold, representing an element of the hearing impairment data 21, is defined as the minimum decibel level at which the hearing-impaired individual 60 can perceive the sound.

For example, after the hearing-impaired individual 60 selects a frequency to test and presses a “PLAY” button 711, the APP increases the volume by “10” decibels every 2 seconds until the individual hears the sound. Upon hearing the sound, the individual presses a “CONFIRM” button 712, and the APP records the decibel level at which the sound was first heard, which is then defined as the hearing threshold for this frequency. In an alternative embodiment, for frequencies that are not explicitly tested, the hearing thresholds are estimated by interpolating between thresholds of the nearest tested frequencies.

The frequency enhancement module 30 is used to establish a gain model based on the hearing threshold differences of tested frequencies between the hearing impairment data 21 and the hearing data of a normal individual. The gain model is applied to compensate in for the hearing-impaired individual's auditory deficiencies by adjusting the audios, ensuring that the hearing-impaired individual 60 perceives the adjusted word audios in a manner similar to how a normal individual perceives them.

In one embodiment, the frequency enhancement module 30 calculates a gain value for each frequency of the word audios based on the hearing difference. The gain values across these frequencies together constitute the gain model. For example, if a normal individual's hearing threshold at a specific frequency is “20” decibels, but the hearing-impaired individual 60 has a hearing threshold of “30” decibels at this specific frequency, the hearing-impaired individual 60 requires a 10-decibel enhancement at that frequency. The system adjusts the word audios accordingly, ensuring they are perceived more clearly by the hearing-impaired individual 60.

When adjusting word audios, the gain model first applies a short-time Fourier transformation (STFT) to convert the word audios from the time domain to the frequency domain, producing a two-dimensional complex array. This array records the amplitude of specific frequencies at specific time points. The gain model then modifies the amplitude values, and finally an inverse short-time Fourier transform (ISTFT) is applied to convert the word audios from the frequency domain back to the time domain, producing the adjusted word audios that are perceived by the hearing-impaired individual 60.

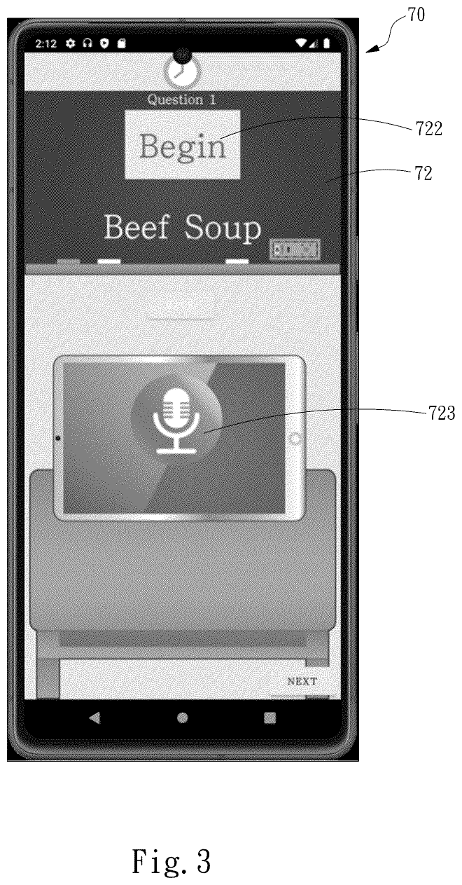

Referring to FIG. 3, the assistive learning module 40 includes a learning interface 72, shown on the mobile device 70. This module is designed to play the adjusted word audios and record the word utterances repeated by the hearing-impaired individual 60 in response to hearing the adjusted word audios. In one embodiment, the assistive learning module 40 is executed via the APP of the mobile phone 70. As shown in FIG. 3, the learning interface 72 features a highly graphical design, which not only captures the attention of the hearing-impaired individual 60 but also makes it easier to understand how to use the APP.

When the hearing-impaired individual 60 presses a “Begin” button 722, the APP randomly selects a word audio (e.g., “Beef Soup” in this display) and adjusts it through the frequency enhancement module 30. The hearing-impaired individual 60 then presses a “Record” button 723 and repeats the adjusted word audio as the hearing-impaired individual 60 hears it. The APP records the sound uttered by the hearing-impaired individual 60. This recorded audio is then compared to the original word audio to assess pronunciation accuracy and provide feedback for further improvement.

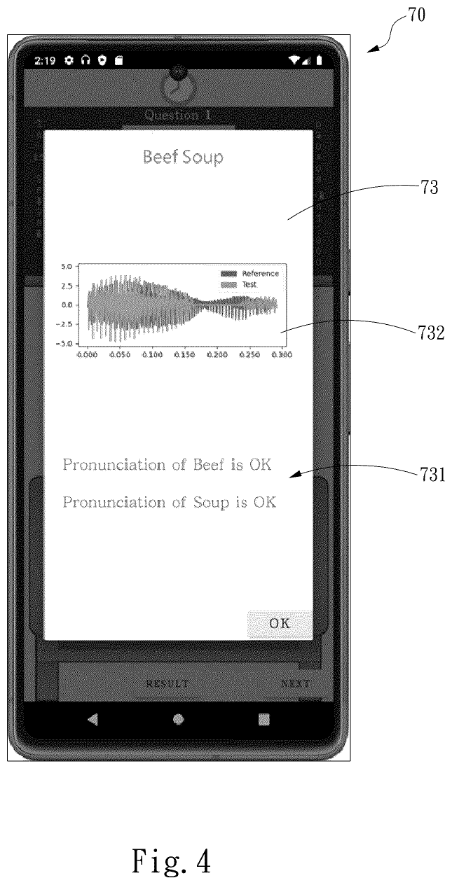

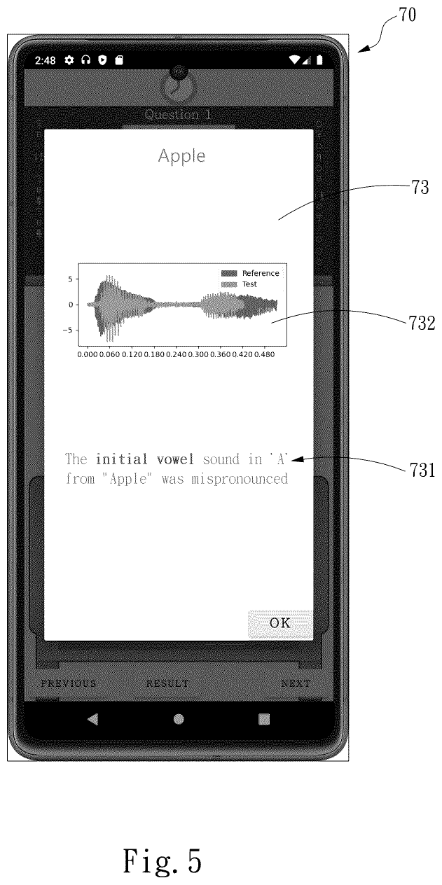

Referring to FIG. 4 and FIG. 5, the assistive learning module 40 includes a display interface 73, shown on the mobile device 70. The speech recognition module 50 performs speech recognition on the word utterances and compares the recognition result with text labels of the word audios. Based on this comparison, a comparison result is obtained and then sent back to the assistive learning module 40, which visually displays the result 731 as a feedback for the hearing-impaired individual 60.

In one embodiment, each of the word audios consists of at least one syllable based on pronunciation. The speech recognition module 50 evaluates each syllable individually by comparing the syllables in word utterances with the corresponding syllables in the word audios. The comparison result 731 then displays any incorrectly pronounced syllables, as illustrated in FIG. 4 and FIG. 5.

The display interface 73 displays the word audio and the comparison result 731. As illustrated in FIG. 4, the comparison result 731 indicates a correct pronunciation. In contrast, FIG. 5 shows the comparison result 731 indicating an error in the pronunciation.

Also, in order to allow the hearing-impaired individual 60 to intuitively identify how to correct the pronunciation, the display interface 73 displays oscillograms 732. The oscillograms visually represent both the reference audio waveform and the waveform of the utterance repeated by the hearing-impaired individual 60. Both waveforms are overlaid for easy comparison.

For performance considerations, the speech recognition module 50 can be hosted on a cloud server (not shown) to avoid performances limitations of the mobile device 70 that might impact user experience. In addition, to provide accurate feedback for improving pronunciation, the speech recognition module 50 employs a speech recognition framework without a language model.

In one embodiment, the present invention adopts a Wav2vec2 acoustic model proposed by the Facebook AI Research team. The Wav2vec2 acoustic model performs self-supervised learning on a large-scale, unlabeled speech data, effectively learning acoustic features. Specifically, this invention uses the wav2vec2-large-xlsr-53 model, pre-trained on 56,000 hours of speech data across 53 languages.

Furthermore, the speech recognition module 50 utilizes a specialized speech recognition model to accurately identify the pronunciation of the hearing-impaired individual 60. This is achieved by fine-tuning the wav2vec2-large-xlsr-53 model on different regional speech datasets, enhancing its adaptability and performance.

In summary, the present invention has the following features.
1. The system generates hearing impairment data for the hearing-impaired individual, uses this data to establish the gain model, and adjusts the word audios accordingly. This enables the hearing-impaired individual to perceive the adjusted audios with an auditory experience comparable to that of a normal listener.
2. By utilizing the assistive learning module and the speech recognition module during repetition learning, the system enables the individual to “hear the correct sounds and learn to replicate them,” avoiding inefficiencies.
3. The system divides word audios into at least one syllable based on pronunciation, and displays the syllables along with the comparison results on the interface. This helps the hearing-impaired individual clearly identify the syllables that require correction.
4. The display interface overlays the waveform of the reference audio with the audio of the hearing-impaired individual's repetitions. This intuitive visualization helps the individual better understand how to correct the pronunciation.

What is claimed is:

1. A pronunciation correction system for hearing-impaired individuals, comprising:
an audiometry module, configured to generate a hearing impairment data of a hearing-impaired individual;
a frequency enhancement module, configured to establish a gain model based on a hearing threshold differences between the hearing impairment data and a hearing data of a normal individual, and the frequency enhancement module configured to adjust word audios by the gain model and generate adjusted audios, when the adjusted audios heard by the hearing-impaired individual, the frequency enhancement module configured to provide an auditory perception experience equivalent to that of a normal individual;
an assistive learning module, configured to play the adjusted audios and capture repeated pronunciations of words spoken by the hearing-impaired individual who hears the adjusted audios;
a speech recognition module, configured to perform a speech recognition on the repeated pronunciations of the words spoken by the hearing-impaired individual, and to compare recognition results with text labels corresponding to the word audios to generate a comparison result, wherein the comparison result is sent back to the assistive learning module, which provides visual feedback to display the comparison result.

2. The pronunciation correction system for the hearing-impaired individuals as claimed in claim 1, wherein the audiometry module is configured to execute a pure tone audiometry method, the pure tone audiometry method includes sequentially playing a plurality of pure tones of different frequencies and volumes, and indicating whether the hearing-impaired individual can hear each pure tone based on responses of the hearing-impaired individual, wherein a hearing threshold is determined for a frequency of each of the plurality of pure tone, and each hearing threshold represents a minimum decibel level at which the hearing-impaired individual can perceive the tone and are recorded as the hearing impairment data.

3. The pronunciation correction system for the hearing-impaired individuals as claimed in claim 2, wherein the frequency enhancement module is configured to assign a gain value to each frequency of the plurality of pure tones based on the hearing threshold difference, and the gain values for the frequencies of the plurality of pure tones collectively constitute the gain model.

4. The pronunciation correction system for the hearing-impaired individuals as claimed in claim 3, wherein the gain model first applies a short-time Fourier transformation (STFT) to convert the word audios from a time domain to a frequency domain, producing a two-dimensional complex array, and the two-dimensional complex array records an amplitude of a specific frequency at a given time point, and wherein the gain model is then applied to adjust the amplitude, followed by an inverse short-time Fourier transform (ISTFT) to convert the word audios from the frequency domain back to the time domain.

5. The pronunciation correction system for the hearing-impaired individuals as claimed in claim 1, wherein the assistive learning module comprises a display interface configured to display the word audios and the comparison result, and the speech recognition module evaluates each syllable individually by comparing the syllables in word utterances with the corresponding syllables in the displayed word audios.

6. The pronunciation correction system for the hearing-impaired individuals as claimed in claim 5, wherein the display interface displays both oscillograms of a reference audio waveform and a waveform of the repeated pronunciations.

7. The pronunciation correction system for the hearing-impaired individuals as claimed in claim 6, wherein the oscillograms of the reference audio and the repeated pronunciation audio are overlapped.
